(19) United States
(12) Patent Application Publication
(10) Pub. No.: US 2020/0226997 A1
(43) Pub. Date: Jul. 16, 2020

(54) LIQUID CRYSTAL DISPLAY DEVICE AND METHOD FOR DRIVING LIQUID CRYSTAL DISPLAY DEVICE

(71) Applicant: SHARP KABUSHIKI KAISHA, Sakai City, Osaka (JP)

(72) Inventor: TARO WATANABE, Sakai City, Osaka (JP)

(73) Assignee: SHARP KABUSHIKI KAISHA, Sakai City, Osaka (JP)

(21) Appl. No.: 16/627,188

(22) PCT Filed: Jun. 28, 2018
(86) PCT No.: PCT/JP2018/024730

§ 371 Date: Dec. 27, 2019

(30) Foreign Application Priority Data
Jul. 5, 2017 (JP) 2017-132281

(51) Int. Cl. G09G 3/36

(52) U.S. Cl. CPC G09G 3/3688; G09G 2310/08; G09G 3/3614

(57) ABSTRACT

A high-display-quality liquid crystal display device, which produces neither flicker nor crosstalk and does not have the risk of causing defective line display even in polarity inversion driving, is implemented. A signal-line drive circuit included in a liquid crystal display device inverts the polarities of data signals, which are applied to selected pixels selected in a certain field, in such a manner that the inversion is performed in the direction along each data signal line by using a corresponding different number of selected pixels as a unit.

### TECHNICAL FIELD

The present invention relates to a liquid crystal display device which performs reverse polarity driving.

### BACKGROUND ART

In driving a liquid crystal module, a fixed voltage applied to a display electrode (direct current driving) will degrade liquid crystal, resulting in failure of normal display. Therefore, typically, a reverse polarity driving method, in which the polarity of the source voltage is inverted at certain periodic intervals, is employed. Examples of the reverse polarity driving method include a column inversion method (FIG. 9) and a dot inversion method (FIG. 10).

The column inversion method and the dot inversion method bring a problem of causing reduction of display quality such as a flicker and crosstalk phenomenon. Accordingly, line reversal driving, in which driving is performed with the polarities of gradation voltages being inverted for every N lines (N≥2), is proposed as a method in which the flicker and crosstalk phenomenon is difficult to occur compared with the dot inversion method and the column inversion method.

However, line reversal driving has a problem in that, when the same gradation and the same color are displayed on the entire screen, a horizontal stripe occurs for every N lines which indicate a polarity inversion cycle, resulting in considerable reduction of the quality of a liquid crystal panel. This is because there is a difference in applied voltage to liquid crystal between an n-th line just after a polarity inversion and the next (n+1)-th line. Accordingly, PTL 1 discloses a technique of adjusting the gradation voltage which is output from a liquid crystal driver in order to achieve such an improvement that no difference in the gradation voltage occurs between the line just after a polarity inversion and the next line.

### CITATION LIST

### Patent Literature

PTL 1: Japanese Unexamined Patent Application Publication No. 2003-84725 (published Mar. 19, 2003)

### SUMMARY OF INVENTION

### Technical Problem

However, the technique disclosed in PTL 1 is just a technique devised under the assumption of line reversal driving. Therefore, polarity inversion occurs in all of the data lines for every N lines. Display, under this condition, of a pattern having an increasing displacement current to the common electrode causes the common electrode voltage to change in a polarity inversion and no charge of desired voltages to pixels, resulting in occurrence of defective line display (horizontal stripes).

An object of an aspect of the present invention is to implement a high-display-quality liquid crystal display device which produces neither flicker nor crosstalk and does not have the risk of causing defective line display, even in reverse polarity driving.

### Solution to Problem

To solve the above-described issue, a liquid crystal display device according to an aspect of the present invention includes a display panel and a data-line drive circuit. The display panel includes a plurality of gate lines, a plurality of data lines, and a plurality of pixels. The plurality of data lines are disposed so as to cross the plurality of gate lines. The plurality of pixels are disposed corresponding to a plurality of crossings between the plurality of gate lines and the plurality of data lines. The data-line drive circuit supplies data signals to the plurality of data lines. The data-line drive circuit inverts the polarities of the data signals applied to selected pixels. The selected pixels are selected in a certain field. The inversion is performed in the direction along each data line by using a corresponding different number of selected pixels as a unit.

### Advantageous Effects of Invention

An aspect of the present invention exerts an effect that a high-display-quality liquid crystal display device may be implemented. Even when reverse polarity driving is performed, the liquid crystal display device produces neither flicker nor crosstalk and does not have the risk of causing defective line display.

### BRIEF DESCRIPTION OF DRAWINGS

FIG. 1 is a schematic block diagram illustrating the configuration of a liquid crystal display device according to a first embodiment of the present invention.

FIG. 2 includes diagrams for describing vertically-striped dot display, to which a method according to the first embodiment for inverting the polarities of data signals is applied.

FIG. 3 includes diagrams for describing vertically-striped dot display to which a method of the related art for inverting the polarities of data signals is applied.

FIG. 4 is a diagram illustrating horizontal stripes occurring when dot display illustrated in FIG. 3 is performed.

FIG. 5 includes diagrams for describing vertically-striped dot display to which a method according to a second embodiment for inverting the polarities of data signals is applied.

FIG. 6 includes diagrams for describing checkered dot display to which a method according to a third embodiment for inverting the polarities of data signals is applied.

FIG. 7 includes diagrams for describing checkered dot display to which a method of the related art for inverting the polarities of data signals is applied.

FIG. 8 is a diagram illustrating dot display illustrated in FIG. 7.

FIG. 9 is a diagram illustrating a display example using the column inversion driving.

FIG. 10 is a diagram illustrating a display example using dot inversion driving.

### DESCRIPTION OF EMBODIMENTS

### First Embodiment

An embodiment of the present invention will be described in detail below.

(The Overview of a Liquid Crystal Display Device)

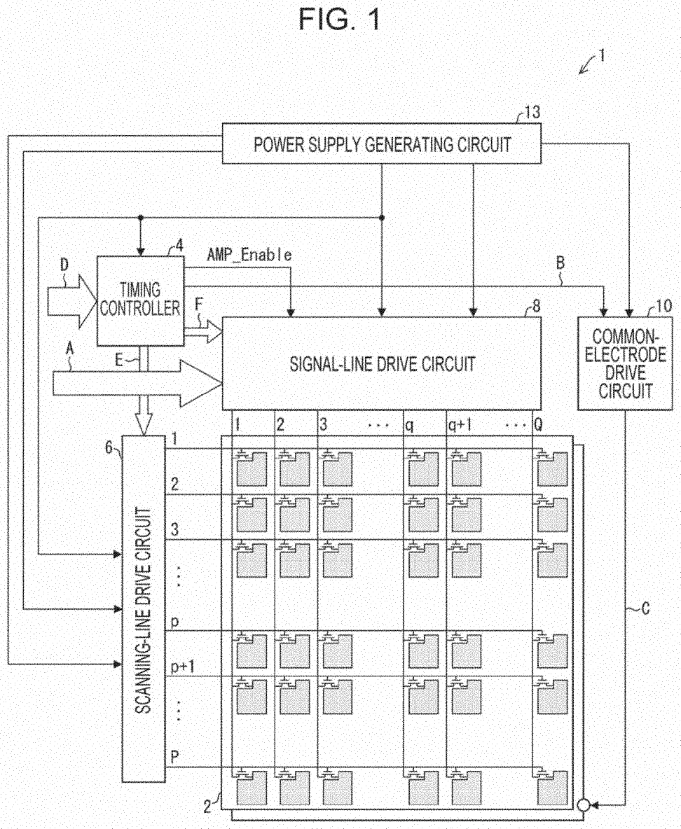

The configuration of a liquid crystal display device 1 according to the present embodiment will be described by referring to FIG. 1. The entire configuration of the liquid crystal display device 1 according to a first embodiment is illustrated in the figure.

As illustrated in FIG. 1, the liquid crystal display device 1 includes a display panel 2, a timing controller 4 (controller), a scanning-line drive circuit 6 (gate-line drive circuit), a signal-line drive circuit 8 (data-line drive circuit), a common-electrode drive circuit 10, and a power supply generating circuit 13.

The display panel 2 has scanning lines (gate lines) whose total is P (where P is an integer equal to or greater than one), data signal lines (data lines) whose total is Q (where Q is an integer equal to or greater than one) and which are disposed so as to cross the scanning lines, and multiple sub-pixels disposed corresponding to the crossings between the scanning lines and the data signal lines. As described below, a given number of sub-pixels form a main pixel (picture element) as a unit.

The timing controller 4 obtains a sync signal and a gate clock signal transmitted from the outside (arrow D), and outputs, to the circuits, a signal which serves as a reference for synchronized operations of the circuits included in the liquid crystal display device 1. Specifically, the timing controller 4 supplies the scanning-line drive circuit 6 with a gate start pulse signal, a gate clock signal GCK, and a gate output control signal GOE (arrow E). In addition, the timing controller 4 outputs, to the signal-line drive circuit 8, a source start pulse signal, a source latch strobe signal, a source clock signal, and a polarity inversion signal (arrow F).

The timing controller 4 controls the operations of the scanning-line drive circuit 6 and the signal-line drive circuit 8. Thus, the timing controller 4 drives the liquid crystal display device 1 by using an interlace drive method in which one frame is formed of multiple fields.

Specifically, the timing controller 4 uses the gate output control signal GOE to control the timing at which the scanning-line drive circuit 6 scans (selects) scanning lines. In addition, the timing controller 4 uses the polarity inversion signal to control the polarities of the data signals supplied from the signal-line drive circuit 8.

The scanning-line drive circuit 6 starts scanning the scanning lines in response to the gate start pulse signal received from the timing controller 4. When the scanning-line drive circuit 6 starts scanning, the scanning-line drive circuit 6 applies, to each scanning line, a select voltage sequentially from the first scanning line of the display panel 2 in accordance with the gate clock signal GCK and the gate output control signal GOE received from the timing controller 4. The scanning-line drive circuit 6 supplies each scanning line sequentially with a scanning signal (gate signal) which indicates a voltage for switching on the switching devices (TFT) included in the sub-pixels on the scanning line. Thus, the scanning-line drive circuit 6 selects and scans each scanning line sequentially. Hereinafter, supply of a scanning signal which indicates a voltage for switching on switching devices is also described as scanning a scanning line.

Specifically, the scanning-line drive circuit 6 selects each scanning line sequentially in accordance with the received gate clock GCK signal. Then, the scanning-line drive circuit 6 applies the select voltage to the selected scanning line at the timing of detecting a falling edge of the received gate output control signal GOE. Thus, the scanning-line drive circuit 6 scans the selected scanning line. The scanning-line drive circuit 6 may perform interlace drive as described below.

The signal-line drive circuit 8 stores, in a register, input image data of the sub-pixels in accordance with the source clock signal on the basis of the source start pulse signal received from the timing controller 4. The signal-line drive circuit 8 supplies the data signal lines of the display panel 2 with data signals, which indicate image data, in accordance with the next source latch strobe signal. Thus, the signal-line drive circuit 8 charges the pixel electrodes included in the sub-pixels including the data signal lines.

Specifically, the signal-line drive circuit 8 calculates the voltage values, which are to be output to the sub-pixels on the selected scanning line, on the basis of an input image signal (arrow A). Then, the signal-line drive circuit 8 outputs, to the data signal lines, voltages having the values. As a result, image data is supplied to the sub-pixels on the selected scanning line.

Further, the signal-line drive circuit 8 inverts the polarities of data signals, which are applied to the selected pixels selected in a certain field, in accordance with the polarity inversion signal received from the timing controller 4 in such a manner that the inversion is performed in the direction along each data line by using a corresponding different number of selected pixels as a unit.

The power supply generating circuit 13 generates voltage necessary for operations of the circuits in the liquid crystal display device 1. Then, the power supply generating circuit 13 outputs the generated voltage to the scanning-line drive circuit 6, the signal-line drive circuit 8, the timing controller 4, and the common-electrode drive circuit 10.

The liquid crystal display device 1 includes a common electrode (not illustrated) provided for the sub-pixels in the display panel 2. The common-electrode drive circuit 10 outputs, to the common electrode, a given common voltage (arrow C) for driving the common electrode, on the basis of a signal which is received from the timing controller 4 (arrow B).

(Reverse Drive)

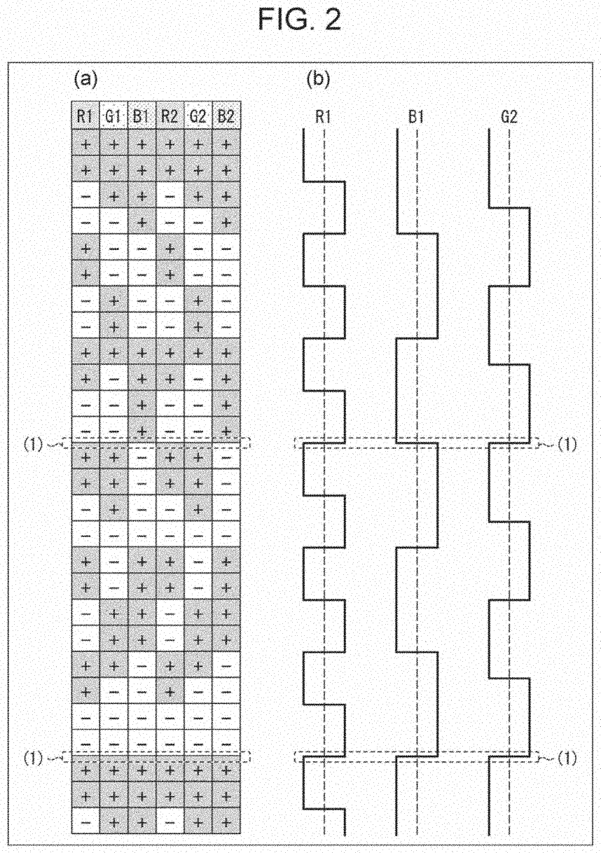

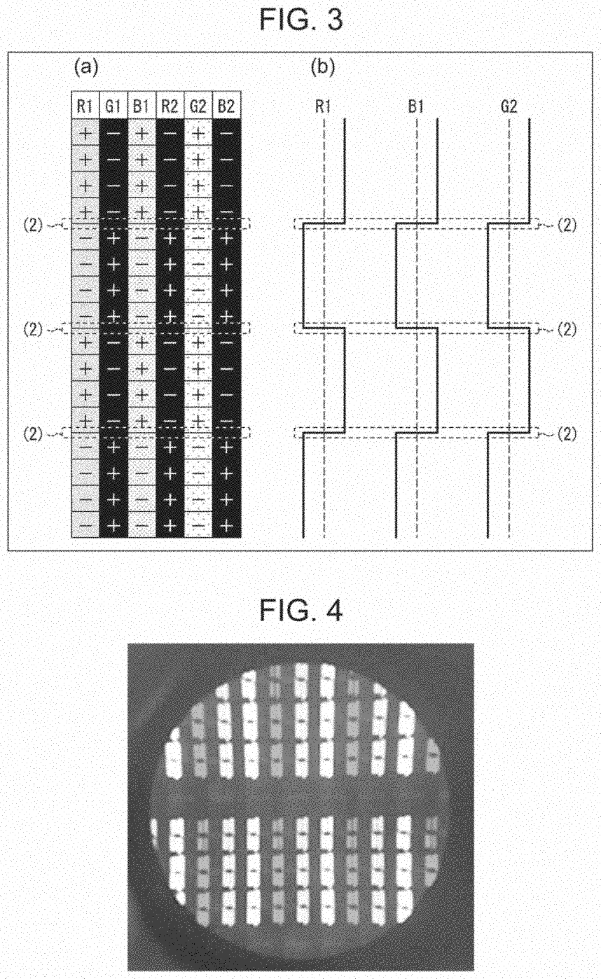

The reverse drive and its effects of the display panel 2 in the liquid crystal display device 1 according to the present embodiment will be described below by referring to FIGS. 2 to 4. FIG. 2 includes diagrams for describing vertically-striped dot display to which the method according to the present embodiment for inverting the polarities of data signals is applied. FIG. 3 includes diagrams for describing vertically-striped dot display to which a method of the related art for inverting the polarities of data signals is applied. FIG. 4 is a diagram illustrating a display example of horizontal stripes. In FIGS. 2 and 3, the signal input side is located in upper portions of the drawings.

As illustrated in FIGS. 2 and 3, three sub-pixels (a sub-pixel R for displaying red, a sub-pixel B for displaying blue, and a sub-pixel G for displaying green) for individually displaying the three primary colors are used as a unit to form a single main pixel (picture element). In FIGS. 2 and 3, for the convenience of description, main pixels on two data lines are displayed. That is, the main pixel of the first data line is formed of the sub-pixels R1, G1, and B1, and the main pixel of the second data line is formed of the sub-pixels R2, G2, and B2. Hereinafter, the description will be made in the following manner: the data line of the Rm pixel (m=an integer equal to or greater than one) is referred to as the Rm line; the data line of the Gm pixel (m=an integer equal to or greater than one) is referred to as the Gm line; the data line of the Bm pixel (m=an integer equal to or greater than one) is referred to as the Bm line.

In the present embodiment, an nH dot inversion method (n≥2) is employed. As illustrated in FIG. 2, the inversion cycles of the Rm line, the Gm line, and the Bm line are set to 2H (two horizontal times), 3H (three horizontal times), and 4H (four horizontal times), respectively. In this case, the polarity inversions of the Rm line, the Gm line, and the Bm line occur at the same timing at 12H and 24H indicated by (1) in FIG. 2. That is, in the case of the present embodiment, the polarity inversions in all of the data lines occur at the same timing at every 12H.

In contrast, in the method (4H line reversal driving) of the related art for inverting the polarities of data signals, the polarity inversions of the Rm line, the Gm line, and the Bm line occur at the same timing at 4H indicated by (2) in FIG. 3. That is, in the case of 4H line inversion, the polarity inversions in all of the data lines occur at the same timing at every 4H.

Typically, in the case of the nH line reversal driving, the polarity inversions in all of the data lines occur at the same timing at every nH. In this condition, if only data lines having the same polarity inversion cycle are lit, displacement currents that flow to the common electrode in polarity inversion do not cancel each other out between adjacent data lines. That is, the displacement current flowing to the common electrode is made large, which may result in a change in the voltage of the common electrode. In particular, in the case of a large liquid crystal module having a large panel size, the resistance value on the signal input side of the common electrode may be different from that on the non-input side. That is, the following case may occur. The resistance value of the common electrode is relatively low on the signal input side. Even if a displacement current occurs as described above, the common electrode voltage is stable, and display defects do not occur. In contrast, the resistance value on the non-input side of the common electrode is high. The voltage may change due to a displacement current, and display defects may occur. For example, as illustrated in FIG. 3(a), in the case of the 4H line reversal driving, the polarity inversion in RGB data lines occurs every 4H. When every-other-dot vertical stripe pattern is displayed, as illustrated (2) in FIG. 3(b), the displacement current increases at every 4H. In these portions, the common electrode voltage increases, and display defects such as failure of lighting occur in every 4H data line (the number of occurrences=the number of vertical pixels/4). As illustrated in FIG. 4, so-called horizontal stripes occur.

In contrast, when, as in the present embodiment, the R, G, and B inversion cycles are set to 2H, 3H, and 4H, respectively, as illustrated in FIG. 2(a), spots, at which polarity inversion occurs, (spots indicated by (1) in FIG. 2) are reduced (to the number of vertical pixels/12 (which is the lowest common multiple of 2, 3, and 4)), and, as illustrated in FIG. 2(b), spots, at which the displacement current increases, are reduced in number. Thus, data lines, in which defects occur, are also reduced in number.

Therefore, when the drive method according to the present embodiment is used to display a one-dot vertical stripe pattern, spots, at which polarity inversions simultaneously occur horizontally, (spots indicated by (1) in FIG. 2) are reduced in number compared with the case of the related art (spots indicated by (2) in FIG. 3). That is, in the same H, the load on the common electrode is reduced. Thus, a change in the common electrode voltage is suppressed, and horizontal stripes, which occur in the related art, are lessened.

In the present embodiment, the polarity inversion cycles of all of the RGB data lines are different from each other as illustrated in FIG. 2(a). In this case, as described above, the present embodiment enables a reduction of the number of spots, at which polarity inversions simultaneously occur horizontally, in the case of displaying a one-dot vertical stripe pattern, compared with the case in which the polarity inversion cycles of all of the RGB data lines are the same as in the nH line reversal driving. A second embodiment below describes an example in which spots, at which polarity inversions simultaneously occur horizontally, are further reduced in number in the case of displaying a one-dot vertical stripe pattern.

### Second Embodiment

Another embodiment of the present invention will be described below. For the convenience of description, components having functions identical to those of components described in the above-described embodiment are designated with identical reference numbers, and will not be described.

(Reverse Drive)

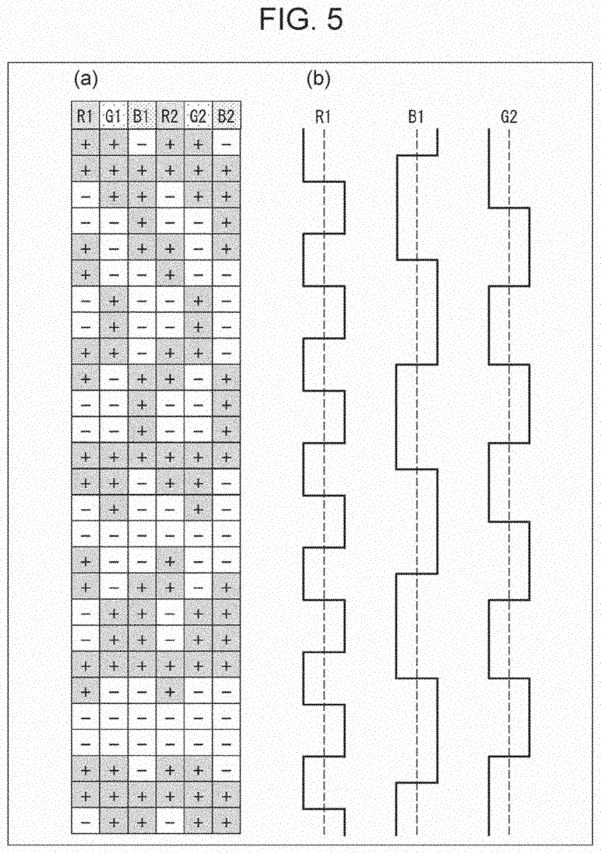

The reverse drive and its effects of the display panel 2 in the liquid crystal display device 1 according to the present embodiment will be described by referring to FIG. 5. FIG. 5 includes diagrams for describing vertically-striped dot display to which a method according to the present embodiment for inverting the polarities of data signals is applied.

In the present embodiment, the same reverse drive as that of the first embodiment is basically applied. That is, also in the present embodiment, similarly to the first embodiment, the nH dot inversion method (n≥2) is employed. As illustrated in FIG. 2, the inversion cycles of the Rm line, the Gm line, and the Bm line are set to 2H (two horizontal times), 3H (three horizontal times), and 4H (four horizontal times), respectively.

In FIG. 5, the phase of the B1 data line and the B2 data line is shifted by 1H with respect to the example illustrated in FIG. 3 in the first embodiment. In FIG. 5, the phase of the B1 and B2 data lines is delayed by 1H with respect to the R1, G1, R2, and G2 data lines. In FIG. 5, the signal input side is located in an upper portion of the drawing.

Thus, the phase of the B data line is delayed by 1H with respect to the R and G data lines. As illustrated in FIGS. 5(a) and 5(b), the horizontal time, at which polarity inversions occurs simultaneously in all of the data lines, may be eliminated.

This solves the following problem occurring due to occurrence of a horizontal time at which polarity inversions occur simultaneously in all of the data lines. The problem is that the displacement current increases and the common electrode voltage increases, resulting in display defects such as no lighting.

Therefore, horizontal stripes caused by occurrence of a horizontal time, in which polarity inversions occurs simultaneously in all of the data lines, may be eliminated. Thus, a liquid crystal display device having high display quality may be achieved.

The first and second embodiments describe the examples in which the reverse polarity driving is applied to vertically-striped dot display. A third embodiment below describes an example in which reverse polarity driving is applied to checkered dot display.

### Third Embodiment

Another embodiment of the present invention will be described below. For the convenience of description, components having functions identical to those of components described in the above-described embodiments are designated with identical reference numbers, and will not be described.

(Reverse Drive)

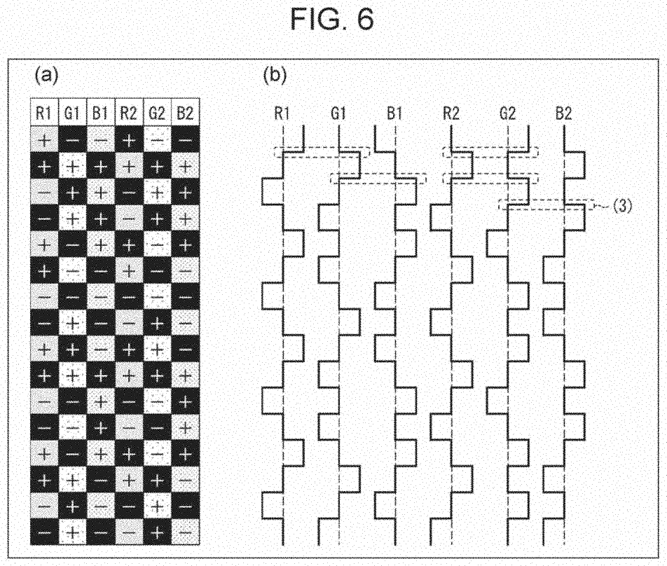

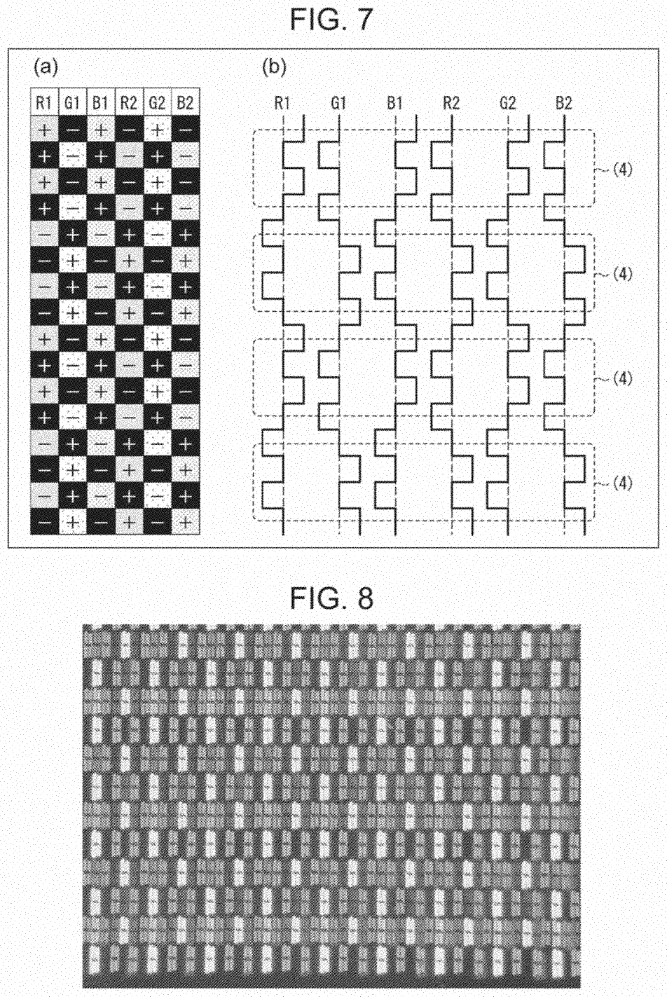

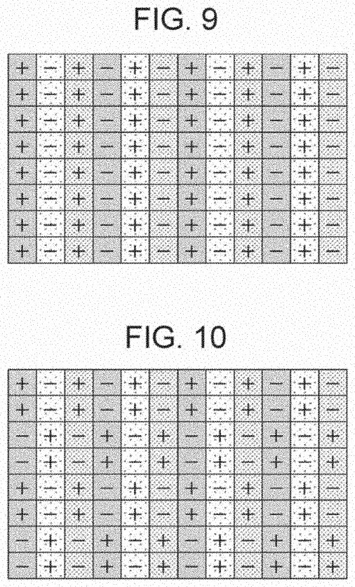

The reverse drive and its effects of the display panel 2 in the liquid crystal display device 1 according to the present embodiment will be described below by referring to FIGS. 2 to 4. FIG. 6 includes diagrams for describing checkered dot display to which a method according to the present embodiment for inverting the polarities of data signals is applied. FIG. 7 includes diagrams for describing checkered dot display to which a method of the related art for inverting the polarities of data signals is applied. FIG. 8 is a diagram illustrating a display example of display defects. In FIGS. 6 and 7, the signal input side is located in upper portions of the drawings.

Also in the present embodiment, the same reverse drive as that of the first embodiment is applied. That is, also in the present embodiment, similarly to the first embodiment, the nH dot inversion method (n 2) is employed. As illustrated in FIG. 2, the inversion cycles of the Rm line, the Gm line, and the Bm line are set to 2H (two horizontal times), 3H (three horizontal times), and 4H (four horizontal times), respectively.

The third embodiment is different from the first and second embodiments in that the reverse polarity driving is applied, not to vertically-striped dot display, but to checkered dot display.

As illustrated in FIG. 7, application of the nH line inversion of the related art to checkered dot display causes display defects as illustrated in FIG. 8.

That is, in application of the nH line inversion of the related art to checkered dot display, voltage change between adjacent data lines is canceled at nH intervals. The voltage change at the other spots (spots indicated by (4) in FIG. 7(b)) is not canceled. Thus, a voltage change in the common electrode occurs, causing display defects (horizontal stripes) as illustrated in FIG. 8.

In contrast, in the present embodiment, as illustrated in FIG. 6(a), assume the case in which the drive method provided by the present invention is applied to checkered dot display. In this case, although a horizontal time, in which voltage changes are canceled among all of the adjacent data lines, is not present, as illustrated in FIG. 6(b), the spots (the spots indicated by (3) in FIG. 6(b)) of horizontal times, in which a voltage change between adjacent data lines is canceled, are dispersed.

This causes a reduction in the voltage change of the common electrode in each horizontal time, resulting in elimination of horizontal stripes of the related art and suppression of display defects.

### Conclusion

A liquid crystal display device according to a first aspect of the present invention includes the display panel 2 and a data-line drive circuit (the signal-line drive circuit 8). The display panel 2 includes a plurality of gate lines (the scanning lines), a plurality of data lines (the data signal lines), and a plurality of pixels. The plurality of data lines (data signal lines) are disposed so as to cross the plurality of gate lines (scanning lines). The plurality of pixels are disposed corresponding to a plurality of crossings between the plurality of gate lines (scanning lines) and the plurality of data lines (data signal lines). The data-line drive circuit (signal-line drive circuit 8) supplies data signals to the plurality of data lines (data signal lines). The data-line drive circuit (signal-line drive circuit 8) inverts the polarities of the data signals applied to selected pixels. The selected pixels are selected in a certain field. The inversion is performed in the direction along each data line (data signal line) by using a corresponding different number of selected pixels as a unit.

The configuration described above causes the polarities of data signals, which are applied to selected pixels selected in a certain field, to be inverted such that the inversion is performed in the direction along each data line by using a corresponding different number of selected pixels as a unit, enabling the polarity inversion cycles of the data lines to be made different from each other.

Thus, even when a pattern in which a displacement current to the common electrode is made large is displayed, the polarity inversion cycles of the data lines are different from each other, resulting in a small amount of change in the voltage of the common electrode in polarity inversion. This enables desired voltages to be charged to pixels, resulting in no occurrence of defective line display (horizontal stripes).

The polarities of data signals applied to the selected pixels selected in a certain field are inverted such that the inversion is performed in the direction along each data line by using a corresponding different number of selected pixels as a unit. Thus, the vertical-direction polarity inversion cycle for dot inversion is made large, achieving reduction in the flicker and crosstalk phenomenon.

Therefore, a high-display-quality liquid crystal display device, which produces neither flicker nor crosstalk and which does not have the risk of causing defective line display, may be implemented.

In a liquid crystal display device according a second aspect of the present invention, in addition to the first aspect, each of the plurality of pixels may be included in a picture element as a unit of three pixels along a corresponding gate line (scanning line), and the three pixels forming the picture element may display three primary colors individually. The numbers of selected pixels of the data lines corresponding to the three pixels forming the picture element may be n, n+1, and n+2 (n≥2), respectively.

According to the configuration described above, the numbers of selected pixels in the data lines corresponding to the three pixels forming a picture element are n, n+1, and n+2 (n≥2), respectively. Thus, the polarity inversion cycles of the data lines corresponding to the respective three primary colors are n cycles, (n+1) cycles, and (n+2) cycles, respectively. Since the polarity inversion cycles of the data lines are made different from each other, the amount of change in the voltage of the common electrode is small in polarity inversion. Thus, desired voltages may be charged to pixels, resulting in no occurrence of defective line display (horizontal stripes).

In a liquid crystal display device according to a third aspect of the present invention, in addition to the second aspect, the data signals supplied to the data lines (data signal lines) may be data signals which cause the display panel 2 to perform vertically-striped dot display.

According to the configuration described above, data signals supplied to the data lines are data signals which cause the display panel to perform vertically-striped dot display. Thus, spots, at which polarity inversions occur simultaneously in the horizontal direction (the direction orthogonal to vertical stripes), is reduced in number, resulting in a reduction of the amount of change of in voltage of the common electrode in polarity inversion. This enables desired voltages to be charged to pixels, causing no occurrence of defective line display (horizontal stripes).

In a liquid crystal display device according to a fourth aspect of the present invention, in addition to the third aspect, polarity inversion phases of data signals supplied to adjacent data lines (data signal lines) may be shifted so as to have a phase difference of one horizontal time.

According to the configuration described above, the polarity inversion phases of data signals supplied to adjacent data lines are shifted so as to have a phase difference of one horizontal time. Thus, spots, at which polarity inversions occur simultaneously in the horizontal direction (the direction orthogonal to vertical stripes), may be further reduced in number.

In a liquid crystal display device according to a fifth aspect of the present invention, in addition to the second aspect, the data signals supplied to the data lines (data signal lines) may be data signals which cause the display panel 2 to perform checkered dot display.

According to the configuration described above, data signals supplied to the data lines are data signals which cause the display panel to perform checkered dot display. Thus, although a horizontal time, in which voltage change is canceled among all of the adjacent data lines, is not present, the spots, at which voltage changes of the common electrode occur, may be dispersed. This enables a reduction of change in the voltage of the common electrode at each horizontal time and charge of desired voltages to pixels, resulting in no occurrence of defective line display (horizontal stripes).

In a liquid crystal display device according to a sixth aspect of the present invention, in addition to any one of the second to fifth aspects, the three primary colors may be red (R), green (G), and blue (B).

There is provided a method according to a seventh aspect of the present invention for driving a liquid crystal display device including a display panel. The display panel includes a plurality of pixels disposed corresponding to a plurality of crossings between a plurality of gate lines and a plurality of data lines. The polarities of the data signals applied to selected pixels are inverted. The selected pixels are selected in a certain field. The inversion is performed in the direction along each data line by using a corresponding different number of selected pixels as a unit.

The configuration described above exerts the same effects as those of the first aspect.

The present invention is not limited to the embodiments described above. Various changes may be made in the scope indicated by the claims. An embodiment obtained by appropriately combining technical means disclosed in respective different embodiments is also encompassed in the technical scope of the present invention. Further, a combination of technical means disclosed in the embodiments may form a novel technical characteristic.

### REFERENCE SIGNS LIST

1 liquid crystal display device
2 display panel
4 timing controller
6 scanning-line drive circuit
8 signal-line drive circuit (data-line drive circuit)
10 common-electrode drive circuit
13 power supply generating circuit
GCK gate clock
GCK gate clock signal
GOE gate output control signal
R1, G1, B1 sub-pixel
R2, G2, B2 sub-pixel

1. A liquid crystal display device comprising:
a display panel that includes a plurality of gate lines, a plurality of data lines, and a plurality of pixels, the plurality of data lines being disposed so as to cross the plurality of gate lines, the plurality of pixels being disposed corresponding to a plurality of crossings between the plurality of gate lines and the plurality of data lines; and
a data-line drive circuit that supplies data signals to the plurality of data lines,
wherein the data-line drive circuit inverts polarities of the data signals applied to selected pixels, the selected pixels being selected in a certain field, the inversion being performed in the direction along each data line by using a corresponding different number of selected pixels as a unit.

2. The liquid crystal display device according to claim 1,
wherein each of the plurality of pixels is included in a picture element as a unit of three pixels along a corresponding gate line, and the three pixels forming the picture element display three primary colors individually, and
wherein the numbers of selected pixels of the data lines corresponding to the three pixels forming the picture element are n, n+1, and n+2 (n≥2), respectively.

3. The liquid crystal display device according to claim 2,
wherein the data signals supplied to the data lines are data signals which cause the display panel to perform vertically-striped dot display.

4. The liquid crystal display device according to claim 3,
wherein polarity inversion phases of data signals supplied to adjacent data lines are shifted so as to have a phase difference of one horizontal time.

5. The liquid crystal display device according to claim 2,
wherein the data signals supplied to the data lines are data signals which cause the display panel to perform checkered dot display.

6. The liquid crystal display device according to claim 2,
wherein the three primary colors are red (R), green (G), and blue (B).

7. A method for driving a liquid crystal display device including a display panel, the display panel including a plurality of pixels, the plurality of pixels being disposed corresponding to a plurality of crossings between a plurality of gate lines and a plurality of data lines,
wherein polarities of the data signals applied to selected pixels are inverted, the selected pixels being selected in a certain field, the inversion being performed in the direction along each data line by using a corresponding different number of selected pixels as a unit.
